(19) United States
(12) Patent Application Publication
(10) Pub. No.: US 2026/0253295 A1
(43) Pub. Date: Aug. 27, 2026

(54) VIDEO GENERATION MODEL TRAINING

(71) Applicant: Tencent Technology (Shenzhen) Company Limited, Shenzhen (CN)

(72) Inventor: Peiji YANG, Shenzhen (CN)

(73) Assignee: Tencent Technology (Shenzhen) Company Limited, Shenzhen (CN)

(21) Appl. No.: 19/653,087

(22) Filed: Apr. 20, 2026

Related U.S. Application Data
(63) Continuation of application No. PCT/CN2025/081595, filed on Mar. 10, 2025.

(30) Foreign Application Priority Data
Apr. 2, 2024 (CN) 202410395181.6

(51) Int. Cl. G06T 13/20; G06T 3/60; G06T 13/40; G06V 10/774; G06V 10/776; G10L 15/06; G10L 21/013; G10L 25/57

(52) U.S. Cl. CPC G06T 13/205; G06T 3/60; G06T 13/40; G06V 10/774; G06V 10/776; G10L 15/063; G10L 21/013; G10L 25/57

(57) ABSTRACT

In a method for video generation model training, at least two first sample pairs are obtained, each of the first sample pairs including a first sample speech segment and a first sample video segment, the first sample video segment of each of the first sample pairs including images of a respective virtual object, and a facial expression of the virtual object in the first sample video segment matching speech content of the first sample speech segment. In the method, a respective predicted video segment corresponding to the first sample speech segment is generated through a video generation model based on the first sample speech segment of each of the first sample pairs. In the method, the video generation model is trained based on the predicted video segment and the first sample video segment corresponding to the first sample speech segment. Apparatus and non-transitory computer-readable storage medium counterparts are also contemplated.

### RELATED APPLICATIONS

The present application is a continuation of International Application No. PCT/CN2025/081595, filed on Mar. 10, 2025, which claims priority to Chinese Patent Application No. 202410395181.6, filed on Apr. 2, 2024, and entitled “METHOD AND APPARATUS FOR TRAINING VIDEO GENERATION MODEL, DEVICE, STORAGE MEDIUM, AND PRODUCT.” The entire disclosures of the prior applications are hereby incorporated by reference.

### FIELD OF THE TECHNOLOGY

This disclosure relates to the field of artificial intelligence technologies, including a method and an apparatus for training a video generation model, a device, a storage medium, and a product.

### BACKGROUND

In recent years, a speech-driven three-dimensional (3D) facial technology has been increasingly and widely applied to various fields. The speech-driven 3D facial technology may refer to converting a speech into a 3D facial expression related to speech content. This technology may be applied to fields such as a speech assistant and a virtual object. For example, a facial expression of the virtual object may be synchronized with the speech.

In a related technology, when the facial expression is generated based on the speech, a phoneme-viseme method may be used. For example, a correspondence between a phoneme and a viseme in the speech is established, and the facial expression is generated through the correspondence. A phoneme may refer to a smallest pronunciation unit having a distinguishing meaning in a human language. A viseme may refer to a phoneme presented in a visual mode and is configured for portraying a mouth posture during pronunciation. However, a one-to-one correspondence may not exist between the phoneme and the viseme. For example, different phonemes may correspond to the same viseme, so that the same facial expression may be generated based on different speeches, leading to a low matching degree between the facial expression and the speech.

### SUMMARY

Aspects of this disclosure provide a method and an apparatus for training a video generation model, a device, a storage medium, and a product, which corresponds to generating, for a virtual object, a facial expression matching speech content based on a speech segment. Some aspects of technical solutions provided in this disclosure are as follows.

According to an aspect, a method for video generation model training is provided. In the method, at least two first sample pairs are obtained, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs. In the method, a respective predicted video segment corresponding to the first sample speech segment of each of the first sample pairs is generated by processing circuitry through a video generation model based on the first sample speech segment of each of the first sample pairs. In the method, the video generation model is trained by the processing circuitry based on the predicted video segment and the first sample video segment corresponding to the first sample speech segment of each of the first sample pairs.

According to an aspect, an apparatus for video generation model training is provided. The apparatus includes processing circuitry configured to obtain at least two first sample pairs, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs. The processing circuitry is configured to generate, through a video generation model based on the first sample speech segment of each of the first sample pairs, a respective predicted video segment corresponding to the first sample speech segment of each of the first sample pairs. The processing circuitry is configured to train the video generation model based on the predicted video segment and the first sample video segment corresponding to the first sample speech segment of each of the first sample pairs.

According to an aspect, a non-transitory computer-readable storage medium is provided. The non-transitory computer-readable storage medium stores instructions, which when executed by a processor, cause the processor to perform a method for video generation model training. In the method, at least two first sample pairs are obtained, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs. In the method, a respective predicted video segment corresponding to the first sample speech segment of each of the first sample pairs is generated through a video generation model based on the first sample speech segment of each of the first sample pairs. In the method, the video generation model is trained based on the predicted video segment and the first sample video segment corresponding to the first sample speech segment of each of the first sample pairs.

According to an aspect, a method for video generation model training is provided and is performed by a computer device. The method includes: obtaining at least two first sample pairs, each of the first sample pairs including a first sample speech segment and a first sample video segment corresponding to the first sample speech segment, and a facial expression of a virtual object in the first sample video segment matching speech content of the first sample speech segment; determining, by a video generation model based on the first sample speech segment of each of the at least two first sample pairs, a predicted video segment corresponding to the first sample speech segment of each of the at least two first sample pairs, the video generation model being configured to generate a video segment based on a speech segment; and training the video generation model based on the predicted video segment and the first sample video segment corresponding to the first sample speech segment of each of the at least two first sample pairs.

According to another aspect, an apparatus for training a video generation model is provided. The apparatus includes: an obtaining module, configured to obtain at least two first sample pairs, each of the first sample pairs including a first sample speech segment and a first sample video segment corresponding to the first sample speech segment, and a facial expression of a virtual object in the first sample video segment matching speech content of the first sample speech segment; a processing module, configured to determine, through a video generation model based on the first sample speech segment of each of the at least two first sample pairs, a predicted video segment corresponding to the first sample speech segment of each of the at least two first sample pairs, the video generation model being configured to generate a video segment based on a speech segment; and a training module, configured to train the video generation model based on the predicted video segment and the first sample video segment corresponding to the first sample speech segment of each of the at least two first sample pairs.

According to another aspect, a computer device is provided. The computer device includes processing circuitry (e.g., a processor) and a memory (e.g., including a non-transitory computer-readable storage medium). The memory is configured to store at least one program (e.g., instructions). The at least one program is loaded and executed by the processor to implement a method for training a video generation model according to one or more examples of this disclosure.

According to another aspect, a non-transitory computer-readable storage medium is provided, the non-transitory computer-readable storage medium storing at least one program (e.g., instructions), the at least one program being loaded and executed by a processor to implement a method for training a video generation model according to one or more examples of this disclosure.

According to another aspect, a computer program product is provided. The computer program product includes at least one program. The at least one program is stored in a non-transitory computer-readable storage medium. Processing circuitry (e.g., a processor) of a computer device reads the at least one program from the non-transitory computer-readable storage medium, and the processor executes the at least one program to cause the computer device to perform a method for training a video generation model according to one or more examples of this disclosure.

Aspects of this disclosure provide a method for training a video generation model. The method trains the video generation model based on a sample speech segment and a sample video segment corresponding to the sample speech segment. A facial expression of a virtual object in the sample video segment matches speech content of the sample speech segment, and then, the video generation model is continuously trained through the sample video segment as a target, so that the video generation model can gradually learn how to more accurately generate, based on a speech segment, a facial expression matching the speech content. The video generation model obtained through training as described herein may generate a video segment synchronous with a speech segment. In some examples, a facial expression of a virtual object in the video segment matches speech content. In an example, by using the video generation model obtained through training, the facial expression matching the speech content may be generated for the virtual object based on the speech segment. For example, when the video generation model obtained through training is applied to a live streaming scenario through a virtual person, a more natural and accurate facial expression may be generated for the virtual person, thereby improving user experience. In addition, the facial expression is generated based on the video generation model, so that convenience and efficiency of generating the facial expression can be improved.

### BRIEF DESCRIPTION OF THE DRAWINGS

FIG. 1 is a schematic diagram of an implementation environment according to an aspect of this disclosure.

FIG. 2 is a flowchart of a method for training a video generation model according to an aspect of this disclosure.

FIG. 3 is a flowchart of another method for training a video generation model according to an aspect of this disclosure.

FIG. 4 is a flowchart of yet another method for training a video generation model according to an aspect of this disclosure.

FIG. 5 is a schematic diagram of extension of model training data according to an aspect of this disclosure.

FIG. 6 is a flowchart of training of a video generation model according to an aspect of this disclosure.

FIG. 7 is a schematic diagram of an application scenario of a video generation model according to an aspect of this disclosure.

FIG. 8 is a flowchart of a live streaming scenario through a virtual person according to an aspect of this disclosure.

FIG. 9 is a schematic diagram of a game interface according to an aspect of this disclosure.

FIG. 10 is a schematic diagram of adjustment of a sample video frame according to an aspect of this disclosure.

FIG. 11 is a flowchart of training of a sample video processing model according to an aspect of this disclosure.

FIG. 12 is a flowchart of obtaining of training data according to an aspect of this disclosure.

FIG. 13 is a schematic diagram of an apparatus for training a video generation model according to an aspect of this disclosure.

FIG. 14 is a block diagram of a terminal according to an aspect of this disclosure.

FIG. 15 is a block diagram of a server according to an aspect of this disclosure.

### DETAILED DESCRIPTION

Descriptions of terms in this disclosure are provided as examples only and are not intended to limit the scope of the disclosure.

Artificial intelligence (AI) may correspond to a theory, a method, a technology, and an application system that use a digital computer or a machine controlled by the digital computer to simulate, extend, and expand human intelligence, perceive an environment, obtain knowledge, and use knowledge to obtain an optimal result. AI may be a comprehensive technology in computer science and attempts to understand the essence of intelligence and produce a new intelligent machine that can respond in a manner similar to human intelligence. AI may be used to study design principles and implementation methods of various intelligent machines to enable the machines to have functions of perception, reasoning, and decision-making. AI technology is a comprehensive discipline, and involves a wide range of fields including both the hardware-level technology and the software-level technology. The basic AI technologies may include technologies such as a sensor, a dedicated AI chip, cloud computing, distributed storage, a big data processing technology, a model pre-training technology, an operating/interaction system, and electromechanical integration. A pre-trained model is also referred to as a large model or a basic model, which may be widely applied to downstream tasks in various fields of AI after fine tuning. AI software technologies may include several major directions such as a computer vision (CV) technology, a speech processing technology, a natural language processing (NLP) technology, and machine learning/deep learning.

Machine learning (ML) may correspond to a multi-field interdiscipline, and relates to a plurality of disciplines such as the probability theory, statistics, the approximation theory, convex analysis, and the algorithm complexity theory. ML may specialize in studying how a computer simulates or implements learning behaviors of humans to obtain new knowledge or skills, and reorganize an existing knowledge structure, so as to keep improving performance thereof. ML is the core of AI, is a basic way to make the computer intelligent, and may be applied to various fields of AI. ML and deep learning may include technologies such as an artificial neural network, a belief network, reinforcement learning, transfer learning, inductive learning, and learning from demonstration. The pre-trained model is a latest development achievement of the deep learning and integrates the foregoing technologies.

Some technologies in the field of a speech technology may include an automatic speech recognition (ASR) technology, a text-to-speech (TTS) technology, and a voiceprint recognition technology. The ability of a computer to listen, see, speak, and feel is the future development direction of human-computer interaction, and speech is to become one of the most promising human-computer interaction modes in the future. The large model technology brings a deep change to development of the speech technology. For example, a pre-trained model using a transformer architecture has great generality and commonality and may favorably complete speech processing tasks in various aspects.

Natural language processing (NLP) may correspond to an important direction in the fields of computer science and AI, which studies various theories and methods that can implement effective communication between humans and computers through natural language. NLP may relate to natural languages, namely, languages daily used by people, is closely related to linguistics research, and relates to computer science and mathematics. The pre-trained model, an important technology of model training in the field of AI, is developed from a large language model in the field of the NLP. Through fine tuning, the large language model may be widely applied to downstream tasks. The NLP technologies may include technologies such as text processing, semantic understanding, machine translation, robot question-answering, and knowledge graphs.

An implementation environment involved in this disclosure is described below as a non-limiting example.

A method for training a video generation model provided in an aspect of this disclosure may be performed by a computer device, and the computer device may be provided as a server or a terminal. The following describes a schematic diagram of an implementation environment of the method for training a video generation model according to an aspect of this disclosure.

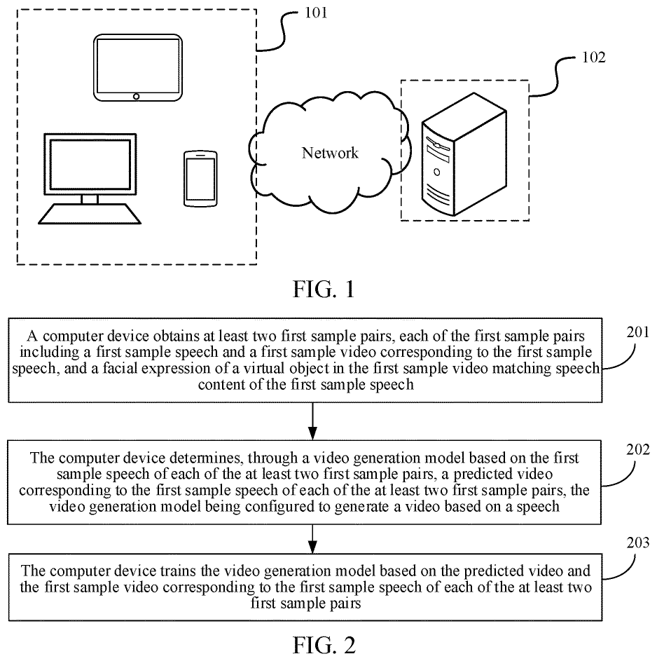

FIG. 1 is a schematic diagram of the implementation environment of the method for training a video generation model according to an aspect of this disclosure. The implementation environment includes a terminal 101 and a server 102. The terminal 101 and the server 102 can be connected directly or indirectly in a wired or wireless communication, which is not limited in this disclosure. In some aspects, the server 102 is configured to train the video generation model. A video generation model obtained through training is configured to generate a video segment based on a speech segment, where a facial expression of a virtual object in the video segment is matched with speech content of the speech segment. A software application is installed on the terminal 101. The software application is configured for generating the video segment based on the speech segment, and then displaying the video segment. In some aspects, the video generation model obtained through training is embedded in the terminal 101, and the terminal 101 generates the video segment based on the speech segment through the video generation model. In some other aspects, the terminal 101 generates the video segment based on the speech segment through the video generation model on the server 102. In this disclosure, the video refers to a series of consecutive image frames. For example, the video is a playable video obtained by recording a real object. For another example, the video is a 3D (three-dimensional) animation that can be rendered to output a series of consecutive image frames and sequentially play the image frames. This is not limited in this disclosure.

In some aspects, the terminal 101 is a smart phone, a tablet computer, a notebook computer, a desktop computer, a smart voice interactive device, a smart household appliance, an on-board terminal, an aircraft, a virtual reality (VR) apparatus, an enhanced reality (AR) apparatus, or the like, but is not limited thereto. In some aspects, the server 102 may be an independent server, or a server cluster or distributed system including at least two servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an AI platform. In some aspects, the server 102 is in charge of primary computing work, and the terminal 101 is in charge of secondary computing work. Alternatively, the server 102 is in charge of the secondary computing services, and the terminal 101 is in charge of the primary computing work. Alternatively, a distributed computing architecture is used between the server 102 and the terminal 101 to perform collaborative computing.

FIG. 2 is a flowchart of a method for training a video generation model according to an aspect of this disclosure. The method is performed by a computer device and includes the following operations.

201: The computer device obtains at least two first sample pairs, each of first sample pairs including a first sample speech segment and a first sample video segment corresponding to the first sample speech segment, and a facial expression of a virtual object in the first sample video segment matching speech content of the first sample speech segment.

In some examples, at least two first sample pairs are obtained, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs.

In the aspects of this disclosure, the first sample video segment includes the virtual object, and the virtual object utters the first sample speech segment and has the facial expression matching the speech content of the first sample speech segment. A virtual object may refer to a movable object in a virtual environment. The movable object may be a virtual person, a virtual animal, a cartoon character, or the like, but is not limited thereto. The virtual object has a shape and a volume in the virtual environment, and occupies a part of space in the virtual environment. The virtual environment may refer to an environment provided (or displayed) when a software application is run on a terminal device, and the virtual environment may be a two-dimensional virtual environment, a 2.5-dimensional virtual environment, a three-dimensional (3D) virtual environment, or the like. For example, when the virtual environment is a three-dimensional virtual environment, the virtual object is a three-dimensional model created based on an animation skeleton technology.

In one or more aspects of this disclosure, that the facial expression matches the speech content means: the facial expression matches at least one of pronunciation, a tone, a speech speed, or an emotional state of the speech content. For example, the pronunciation of the speech content matches a mouth shape of the facial expression. For another example, a serious tone matches a serious facial expression, and a humorous tone matches a humorous facial expression. For another example, a slow speed matches a gentle facial expression. The emotional state is an emotional state expressed through the speech content, and the emotional state may be determined through at least one of a modal particle, the pitch, the speech speed, or the like in the speech content. For example, if the emotional state is happy, a matched facial expression is happy, and if the emotional state is sad, the matched facial expression is sad.

In one or more aspects of this disclosure, the computer device can perform rendering based on the first sample video segment to display the first sample video segment on the computer device. In some aspects, the first sample video segment includes at least two sample video frames, rendering is performed based on the at least two sample video frames, and the first sample video segment including the at least two sample video frames is displayed.

In some aspects, the facial expression of the virtual object is controlled through parameters of at least two expression controllers for a face of the virtual object. Correspondingly, the first sample video segment includes the parameters of the at least two expression controllers for the face of the virtual object. The first sample video segment includes at least two sample video frames. For example, a data form of the first sample video segment is a matrix. Each vector in the matrix is a sample video frame. A quantity of dimensions of each vector is the same as a quantity of expression controllers. An element value of each dimension in the vector represents a parameter of an expression controller. In other words, the parameters of the expression controllers represented by the element value of each dimension in the vector jointly form the sample video frame. In some aspects, the virtual object is a 3D virtual object, the facial expression is a 3D facial expression, and correspondingly, the first sample video segment is a 3D facial animation video.

202: The computer device determines, by a video generation model based on the first sample speech segment of each of the at least two first sample pairs, a predicted video segment corresponding to the first sample speech segment of each of the at least two first sample pairs, the video generation model being configured to generate a video segment based on a speech segment.

In some examples, a respective predicted video segment corresponding to the first sample speech segment of each of the first sample pairs is generated by processing circuitry through a video generation model based on the first sample speech segment of each of the first sample pairs.

In one or more aspects of this disclosure, for each first sample pair, the computer device processes the first sample speech segment in the first sample pair through the video generation model, to obtain a predicted video segment corresponding to the first sample speech segment, and the predicted video segment includes a virtual object. A training target for the video generation model is to generate a video segment based on a speech segment with the facial expression of the virtual object in the video segment matching the speech content.

203: The computer device trains the video generation model based on the predicted video segment and the first sample video segment corresponding to the first sample speech segment of each of at least two first sample pairs.

In some examples, the video generation model is trained by the processing circuitry, based on the predicted video segment and the first sample video segment corresponding to the first sample speech segment of each of the first sample pairs.

In one or more aspects of this disclosure, for each first sample pair, a model parameter of the video generation model is adjusted based on a loss value between the predicted video segments and the first sample video segments of the first sample pair.

In one or more aspects of this disclosure, the computer device performs iterative training on the video generation model based on the predicted video segment and the first sample video segment of each of the at least two first sample pairs, until a preset requirement is satisfied. Satisfying the preset requirement may be that a loss value between the predicted video segment and the first sample video segment reaches convergence, or the loss value reaches a preset threshold, or a quantity of iterations reaches a preset quantity, which is not specifically limited herein.

One or more aspects of this disclosure provide a method for training a video generation model. The method trains the video generation model based on a sample speech segment and a sample video segment corresponding to the sample speech segment. A facial expression of a virtual object in the sample video segment matches speech content of the sample speech segment, and then, the video generation model is continuously trained through the sample video segment as a target, so that the video generation model can gradually learn how to more accurately generate, based on a speech segment, a facial expression matching the speech content. The video generation model obtained through training as described herein may generate a video segment synchronous with a speech segment, and in the video segment, a facial expression of a virtual object matches speech content. In an example, by using the video generation model obtained through training, the facial expression matching the speech content can be generated for the virtual object based on the speech segment. For example, when the video generation model obtained through training is applied to a live streaming scenario through a virtual person, a more natural and accurate facial expression can be generated for the virtual person, thereby improving user experience. In addition, the facial expression is generated based on the video generation model, so that convenience and efficiency of generating the facial expression can be improved.

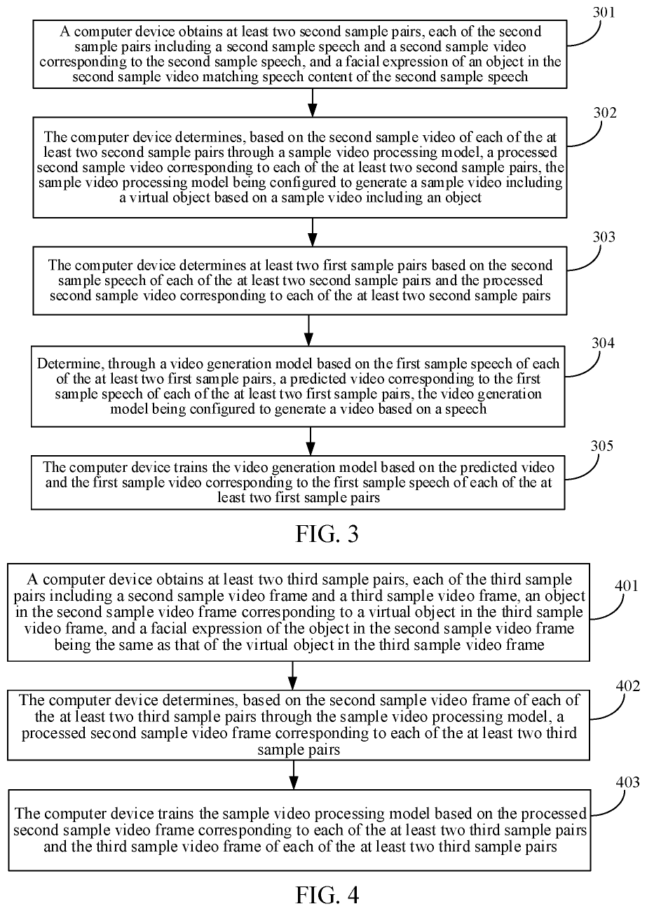

FIG. 2 is a basic process of the method for training a video generation model. The following further describes the method for training a video generation model based on FIG. 3. FIG. 3 is a flowchart of another method for training a video generation model according to an aspect of this disclosure. The method is performed by a computer device, and the method includes the following operations.

301: The computer device obtains at least two second sample pairs, each of the second sample pair including a second sample speech segment and a second sample video segment corresponding to the second sample speech segment, and a facial expression of an object in the second sample video segment matching speech content of the second sample speech segment.

In some examples, at least two second sample pairs are obtained, each of the second sample pairs including a second sample speech segment and a second sample video segment corresponding to the second sample speech segment, the second sample video segment of each of the second sample pairs including images of a respective object, and a facial expression of the object in the second sample video segment of each of the second sample pairs matching speech content of the second sample speech segment of the corresponding one of the second sample pairs.

In an aspect of this disclosure, the second sample video segment includes the object. In some aspects, the second sample video segment corresponding to the second sample speech segment may be a video segment recorded when the object utters a speech, the video segment includes the facial expression of the object, and the second sample speech segment is a recorded speech uttered by the object.

The object in the second sample video segment may be a real object, thereby helping obtain the second sample video segment. The second sample speech segment and the second sample video segment of the object are obtained with authorization of the object. In some aspects, an authorization interface is displayed on a terminal used by the object, and prompt information, an agreeing control, and a disagreeing control are displayed on the authorization interface. The prompt information is configured as a prompt to obtain a speech segment and a video segment of the object, and the agreeing control is configured for instructing the object to allow the terminal to obtain the speech segment and the video segment of the object. The speech segment and the video segment of the object are obtained in response to a trigger operation on the agreeing control.

The objects in the second sample video segments of each of the at least two second sample pairs may be the same object, thereby improving convenience of obtaining the at least two second sample pairs. The objects in the second sample video segments of each of the at least two second sample pairs may be different objects, thereby improving diversity of the samples. The second sample speech segments of each of the at least two second sample pairs may be different. Correspondingly, the second sample video segments of each of the at least two second sample pairs are different, thereby improving diversity of the samples.

302: The computer device determines, based on the second sample video segment of each of the at least two second sample pairs through a sample video processing model, a processed second sample video segment corresponding to each of the at least two second sample pairs, the sample video processing model being configured to generate a sample video segment including a virtual object based on a sample video segment including an object.

In some examples, a respective processed second sample video segment corresponding to each of the second sample pairs is generated through a sample video processing model based on the second sample video segment of each of the second sample pairs, the processed second sample video segment corresponding to each of the second sample pairs including images of a virtual object corresponding to the respective object, a facial expression of the virtual object in the processed second sample video segment matching a facial expression of the respective object in the second sample video segment of the corresponding one of the second sample pairs.

In one or more aspects of this disclosure, for each second sample pair, the second sample video segment in the second sample pair is processed through the sample video processing model to obtain the processed second sample video segment. A facial expression of a virtual object in the processed second sample video segment matches a facial expression of the object in the second sample video segment before processing. In other words, the processed second sample video segment includes the virtual object, and the virtual object not only corresponds to the object in the second sample video segment, but also has a facial expression the same as the facial expression of the object in the second sample video segment.

For a process of training the sample video processing model, reference is made to an example of FIG. 4. Details are not described herein again.

In some aspects, an example in which a sample video frame in the second sample video is referred to as a first sample video frame (another naming mode may also be used, which is not limited) is used. Correspondingly, the computer device performs operation 302, including the following operations:

The computer device determines, for each second sample pair through the sample video processing model, a processed first sample video frame corresponding to each of the at least two first sample video frames based on at least two first sample video frames in the second sample video segment in the second sample pair; and determines, based on the processed first sample video frame corresponding to each of the at least two second sample pairs, a processed second sample video segment corresponding to each of the at least two second sample pairs.

In other words, for a second sample video segment in any second sample pair, the computer device respectively processes each sample video frame in the second sample video segment through the sample video processing model to obtain the processed sample video frame corresponding to each sample video frame, thereby converting each sample video frame including an object to a sample video frame including a virtual object.

The sample video processing model is configured to generate a sample video frame including the virtual object based on the sample video frame including the object. In the sample video frame including the virtual object, the virtual object not only corresponds to the object in the sample video frame including the object, but also has a facial expression the same as a facial expression of the object. For example, in a case that the object in the second sample video segment is a real object, the sample video processing model can generate the facial expression of the virtual object based on the facial expression of the real object to simulate the facial expression of the real object by the virtual object.

In some aspects, the process in which the computer device determines, based on the processed first sample video frame corresponding to each of the at least two second sample pairs, the processed second sample video segments corresponding to each of the at least two second sample pairs includes the following operations.

The computer device sequentially arranges the processed first sample video frames in an ascending order of sampling times based on a sampling time order of the at least two first sample video frames in the second sample video segment of the second sample pair, to obtain the processed second sample video segment. Further, a data form of each processed first sample video frame is a vector, a data form of the processed second sample video segment is a matrix, and at least two vectors are sequentially arranged in an ascending order of sampling times of the at least two first sample video frames, to obtain the processed second sample video segment.

In one or more aspects of this disclosure, each sample video frame in the second sample video segment is processed through the sample video processing model to obtain the sample video frame including the virtual object. In this way, fine processing is implemented, so that each processed sample video frame is accurate, thereby improving accuracy of a sample video segment. In other words, through the sample video processing model, the second sample video segment including the object is converted to the second sample video segment including the virtual object, thereby implementing expansion of a sample. For example, the virtual object is a 3D virtual object, and the object in the second sample video segment is a real object. Through the sample video processing model, a sample video segment including the real object can be converted into a sample video segment including the 3D virtual object, so that the sample video segment including the 3D virtual object is used in a process of training the video generation model, thereby implementing expansion of a sample.

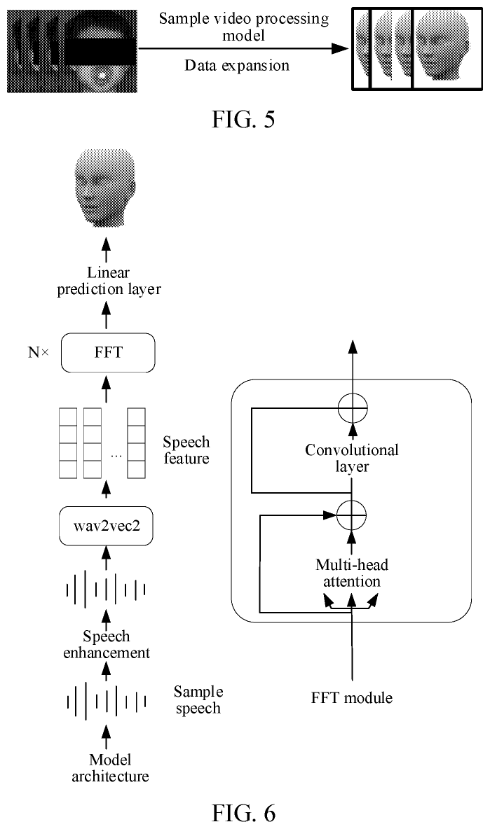

For example, FIG. 5 is a schematic diagram of extension of model training data according to an aspect of this disclosure. The second sample video segment includes the real object. The computer device processes the sample video frame in the second sample video segment through the sample video processing model, to obtain the processed sample video frame corresponding to each sample video frame, and further the processed second sample video segment, so that the processed second sample video segment includes the 3D virtual object, thereby implementing expansion of training data of the video generation model.

303: The computer device determines at least two first sample pairs based on the second sample speech segment of each of the at least two second sample pairs and the processed second sample video segment corresponding to each of the at least two second sample pairs.

In some examples, the first sample pairs are determined based on the second sample speech segment of each of the second sample pairs and the processed second sample video segment corresponding to each of the second sample pairs.

In one or more aspects of this disclosure, each first sample pair includes a first sample speech segment and a first sample video segment corresponding to the first sample speech segment, and a facial expression of a virtual object in the first sample video segment matches speech content of the first sample speech segment.

In some aspects, the computer device adjusts (or enhances) the second sample speech segment to extend a sample. The computer device respectively adjusts (or enhances) the second sample speech segment of each of the at least two second sample pairs, to obtain at least two adjusted second sample speech segments, speech content in each of the adjusted second sample speech segments being the same as that in the corresponding second sample speech segment before adjustment; and determines the at least two first sample pairs based on the second sample speech segment of each of the at least two second sample pairs, the at least two adjusted second sample speech segments, and the processed second sample video segments corresponding to the at least two second sample pairs. For any first sample pair, the first sample speech segment in the first sample pair is a second sample speech segment before adjustment or an adjusted second sample speech segment, and each adjusted second sample speech segment is the same as the second sample video segment corresponding to the second sample speech segment before adjustment. In some examples, each of the first sample pairs may be the second sample video segment of the corresponding one of the second sample pairs paired with the corresponding second sample speech segment or the corresponding adjusted second sample speech segment.

In other words, after obtaining the second sample pair, the computer device may adjust the second sample speech segment in the second sample pair, and use the adjusted second sample speech segment as the first sample speech segment to participate in the process of training the video generation model, or may use the second sample speech segment before adjustment (i.e., an original second sample speech segment) as the first sample speech segment to participate in the process of training the video generation model.

In one or more aspects of this disclosure, the second sample speech segment in each second sample pair is adjusted, and the adjusted second sample speech segment is used as the first sample speech segment to participate in the process of training the video generation model, thereby increasing diversity of a sample. In addition, the video generation model is trained based on these multiple types of samples, which can improve generality of the video generation model.

In some aspects, the process in which the computer device respectively adjusts the second sample speech segment of each of the at least two second sample pairs to obtain at least two adjusted second sample speech segments includes at least one of the following: adjusting a pitch of the second sample speech segment of each of the at least two second sample pairs to obtain the at least two adjusted second sample speech segments; adding reverberation to the second sample speech segment of each of the at least two second sample pairs, to obtain the at least two adjusted second sample speech segments; or adding noise to the second sample speech segment of each of the at least two second sample pairs to obtain the at least two adjusted second sample speech segments.

The pitch may be determined by a frequency of a sound, and the pitch increases and decreases with the frequency. Further, the pitch is also related to a volume of the sound. Therefore, adjusting the pitch of the sample speech segment may refer to adjusting at least one of the frequency or the volume of the sample speech segment, for example, increasing the frequency of the sample speech segment, decreasing the frequency of the sample speech segment, increasing the volume of the sample speech segment, or decreasing the volume of the sample speech segment. In some aspects, the computer device adjusts the pitch of the sample speech segment through a pitch adjustment device, and the pitch adjustment device is a device configured to adjust the pitch.

Adding reverberation to the sample speech segment may refer to adding, to the sample speech segment, an acoustic effect formed through simulation of multiple reflections of a sound in a closed or semi-closed space. For example, reverberations in at least two different scenarios are added to the sample speech segment, to further increase diversity of a sample. The at least two different scenarios may be respectively an indoor scenario, an outdoor scenario, and the like.

Adding noise to the sample speech segment may refer to adding different types of disordered sound signals to the sample speech segment. For example, at least two different types of noise are added to the sample speech segment to further increase diversity of a sample. The different types of noise may include Gaussian noise, white noise, or impulse noise.

The foregoing several modes of adjusting the sample speech segment may be freely combined. For example, at least one of the reverberation or the noise is added to the sample speech segment after pitch adjustment to further increase diversity of a sample. The several modes are merely implementations of adjusting the sample speech segment, and the computer device may further adjust the sample speech segment through another implementation. Details are not described herein again.

In one or more aspects of this disclosure, the pitch of the sample speech segment is adjusted, and the reverberation or noise is added to the sample speech segment, so that a sample is expanded without changing the speech content of the sample speech segment. In addition, the several adjustment modes are highly convenient, thereby improving efficiency of adjusting the sample speech segment.

In one or more aspects of this disclosure, a process of obtaining at least two first sample pairs is implemented through the foregoing operations 301 to 303. In one or more aspects, the sample video segment including the object in the second sample pair may be processed through the sample video processing model, to obtain the sample video segment including the virtual object (i.e., the processed sample video segment). Because the sample speech segment is synchronous with the sample video segment including the object, the sample video segment synchronous with the sample speech segment and including the virtual object is obtained, and then parallel data of the sample speech segment and the sample video segment including the virtual object is obtained. The sample video processing model obtains parallel data of the sample speech segment and the sample video segment including the virtual object, so that it does not need to construct a facial expression of the virtual object in the sample video frame by frame by an animator, thereby improving efficiency of obtaining the sample video segment including the facial expression of the virtual object. These pieces of data are configured for training the video generation model configured to generate a video segment based on a speech segment, thereby improving efficiency of obtaining training data for the video generation model.

The foregoing operations 301 to 303 are merely implementations for obtaining at least two first sample pairs, and the computer device may also implement the process in another implementation. Details are not described herein again.

304: Determines, by a video generation model based on the first sample speech segment of each of the at least two first sample pairs, a predicted video segment corresponding to the first sample speech segment of each of the at least two first sample pairs, the video generation model being configured to generate a video segment based on a speech segment.

In some examples, for each one of the second sample pairs, a processed first sample video frame corresponding to each of the first sample video frames is determined through the sample video processing model based on at least two first sample video frames in the second sample video segment of the corresponding one of the second sample pairs.

In some aspects, the process in which the computer device processes, for each first sample pair, the first sample speech segment in the first sample pair through the video generation model, to obtain a predicted video segment corresponding to the first sample speech segment includes the following operations:

The computer device processes, for each first sample pair, the first sample speech segment in the first sample pair through a feature extraction module in the video generation model, to obtain a speech feature of the first sample speech segment. The feature extraction module is configured to extract a feature of a speech segment. The speech feature is processed through an attention module in the video generation model to obtain an attention feature of the speech feature, the attention module being configured to extract the attention feature; and the attention feature is processed through a regression module in the video generation model to obtain a predicted video segment, the regression module being configured to generate the predicted video segment based on the attention feature.

The following illustrates an implementation of operation 304 by using an example in which the first sample speech segment is an adjusted second sample speech segment with reference to Equation (1) to Equation (4).

Schematically, the second sample speech segment is represented as A={a¹, . . . , a^{T}}, and the predicted video segment is represented as Y={y¹, . . . , y^{M}}. a represents a speech signal, and y represents a video frame. T represents a sampling quantity of the second sample speech segment. Using 16 kHz as an example, the sampling quantity of 1 second is 16000. M represents a quantity of video frames included in a predicted video segment. For example, a 1-second predicted video segment includes 50 video frames.

The computer device adjusts the second sample speech segment through a data adjusting module, to obtain an adjusted second sample speech segment, namely, the first sample speech segment. The process may be represented through the following Equation (1).

$${A}^{′} = {aug}_{a} ( A ) . \qquad ( 1 )$$

A′ represents the adjusted second sample speech segment, namely, the first sample speech segment. A represents the second sample speech segment before adjustment, namely, the original second sample speech segment. augₐ(A) represents adjusting the second sample speech segment A.

In some aspects, the feature extraction module in the video generation model is a wav2vec2 module (a speech feature extraction module). The first sample speech segment is inputted to the feature extraction module to obtain a speech feature. The process may be represented through the following Equation (2).

$${H}_{c} = wav 2 vec 2 ( {A}^{′} ) . \qquad ( 2 )$$

H_{c} represents the speech feature,

$${H}_{c} = \{ {h}_{c}^{1} , … , {h}_{c}^{M} \} ,$$

M represents a quantity of video frames in a predicted video segment. The speech feature includes at least two speech sub-features, and the at least two speech sub-features are in one-to-one correspondence with at least two video frames.

$${h}_{c}^{M}$$

represents a speech sub-feature corresponding to an M^{th} video frame, and wav2vec2(A′) represents extracting a speech feature of A′.

Extracting the speech feature through the wav2vec2 module is merely an implementation, and the computer device may also extract the speech feature through another model. Details are not described herein again.

The attention feature in the video generation model may be a single-head attention feature or a multi-head attention feature, and may be a self-attention feature or a cross-attention feature. In some aspects, the attention module is a multi-layer feed forward transformer (FFT) module. The speech feature is inputted to the attention module, to extract a new depth feature of the speech feature and obtain the attention feature. The process may be represented through the following Equation (3).

$${H}_{d} = FFT ( {H}_{c} ) . \qquad ( 3 )$$

H_{d} represents the attention feature, and FFT(H_{c}) represents extracting the attention feature of the speech feature H_{c}.

In some aspects, the regression module in the video generation model is a fully connected layer, namely, a linear prediction layer, and is configured to perform nonlinear transformation on the attention feature to obtain the predicted video segment. The process may be represented through the following Equation (4).

$${Y}^{′} = Linear ( {H}_{d} ) . \qquad ( 4 )$$

Y′ represents the predicted video segment, and Linear(H_{d}) represents performing the nonlinear transformation on the attention feature H_{d}.

For example, FIG. 6 is a flowchart of training of a video generation model according to an aspect of this disclosure. An original sample speech segment (i.e., a second sample speech segment) is first adjusted to obtain an adjusted sample speech segment (i.e., a first sample speech segment). The adjusted sample speech segment is processed by a wave2vec2 module in a video generation model, to obtain a speech feature. The speech feature is processed through an N-layer FFT module in the video generation model to obtain an attention feature, where Nis an integer greater than 1. The attention feature is processed through the linear prediction layer in the video generation model to obtain the predicted video segment. The FFT module includes a multi-head attention unit and a convolutional layer, and the speech feature is sequentially processed by the multi-head attention unit and the convolutional layer, to obtain the attention feature.

305: The computer device trains the video generation model based on the predicted video segment and the first sample video segment corresponding to the first sample speech segment of each of at least two first sample pairs.

In some examples, the processed second sample video segment corresponding to each of the second sample pairs is determined based on the processed first sample video frames corresponding to each of the second sample pairs.

In some aspects, the computer device determines, for each first sample pair, a loss value between the predicted video segments and the first sample video segments of the first sample pair, and adjusts a model parameter of the video generation model based on the loss value of each first sample pair.

In some aspects, the predicted video segment includes at least two predicted video frames, the first sample video segment includes at least two sample video frames, and the at least two predicted video frames are in one-to-one correspondence with the at least two sample video frames. The foregoing process of training the video generation model through the computer device based on the respective predicted video segments and the first sample video segment of the at least two first sample pairs includes the following operations:

The computer device determines, for each first sample pair, the loss value based on a difference between each of the at least two predicted video frames and each of the at least two sample video frames; and adjusts the model parameter of the video generation model based on the loss value corresponding to each of the at least two first sample pairs.

A quantity of the at least two predicted video frames is the same as a quantity of the at least two sample video frames, and the at least two predicted video frames are in one-to-one correspondence with the at least two sample video frames based on a sampling time. In an example, one predicted video frame corresponds to one sample video frame.

In one or more aspects of this disclosure, the loss value is comprehensively determined based on the differences between the at least two predicted video frames in the predicted video segment and the at least two sample video frames in the first sample video segment, so that the loss value is more accurate. Further, the model parameter is adjusted based on the loss value, so that the model parameter is adjusted more accurately, thereby improving efficiency of model training.

In some aspects, the determining, by the computer device, a loss value based on the difference between each of the at least two predicted video frames and each of the at least two sample video frames includes the following operations: The computer device determines an average value of at least two differences, to obtain the loss value; and alternatively, the computer device determines an average value of squares of at least two differences, to obtain the loss value. In an example, the obtained loss value is an L2 (a least square error) loss value.

For example, the loss value is the L2 loss value, and the process may be expressed through the following Equation (5).

$$L = ‖ Y - {Y}^{′} ‖ . \qquad ( 5 )$$

In Equation (5), L represents the loss value, Y represents the first sample video segment, Y′ represents the predicted video segment, and ∥Y−Y′∥ represents performing calculation of the least square error on Y and Y′.

In one or more aspects of this disclosure, the video generation model obtained through training is configured to generate a video segment based on a speech segment, and a facial expression of a virtual object in the video segment matches speech content of the speech segment.

The video generation model provided in one or more aspects of this disclosure may be applied to scenarios such as live streaming through a virtual person and production of a game role. For example, FIG. 7 is a schematic diagram of the application scenario of the video generation model according to an aspect of this disclosure. A front module is configured to generate a speech segment, the speech segment is configured for obtaining a video segment through the video generation model in a speech-driven facial service, and a facial expression of a virtual object in the video segment matches speech content of the speech segment.

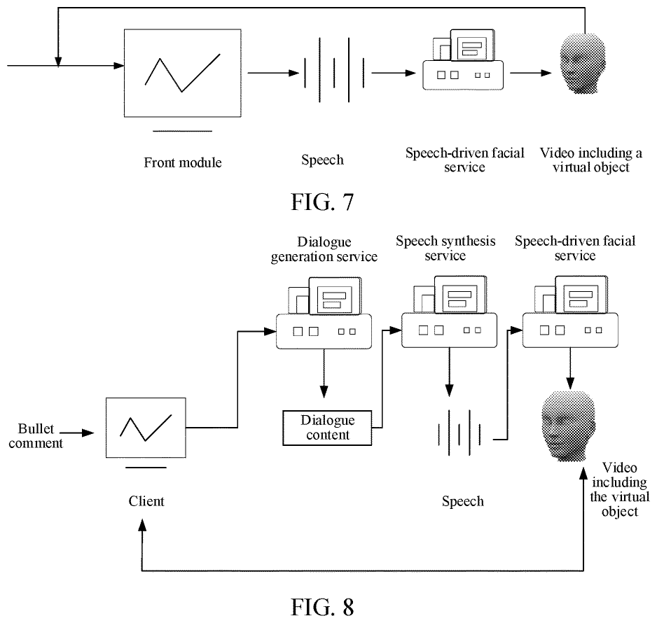

In some aspects, the method provided in this disclosure is applied to the live streaming scenario through the virtual person. A live streaming client captures a viewer's bullet comment on a live streaming interface and generates a responding dialogue through a dialogue generation service. Dialogue content of the dialogue is configured for generating a responding speech through a speech synthesis service, and then generating a video synchronous with the speech through a video generation module (implemented through the video generation model provided in this disclosure) in a speech-driven facial service, and the video is displayed. A virtual live streamer in the video makes a facial expression matching speech content to implement dialogue interaction with the viewer's bullet comment. For example, FIG. 8 is a flowchart of a live streaming scenario through a virtual person according to an aspect of this disclosure.

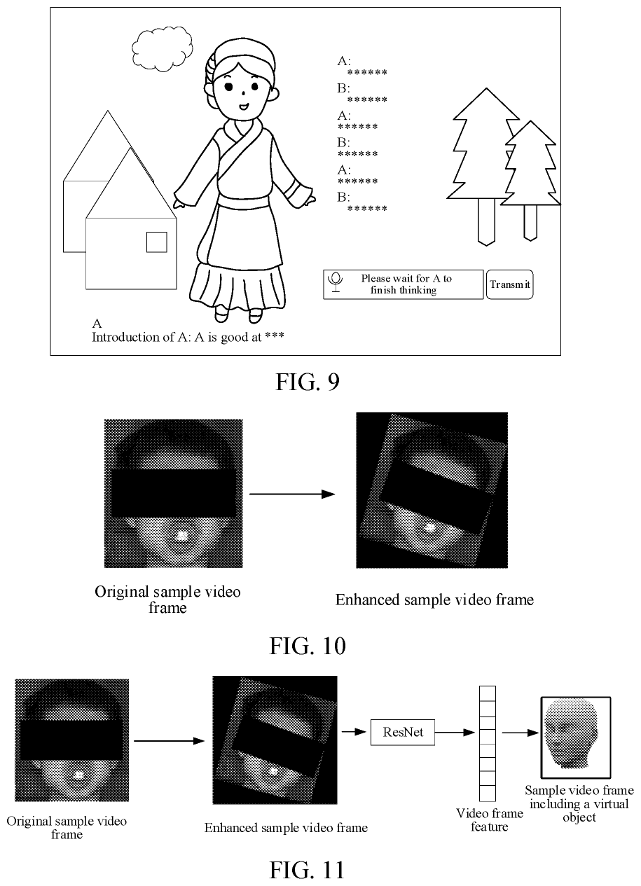

In some other aspects, the method provided in this disclosure is used in a game non-player character (NPC) scenario. A game object may have a dialogue with a virtual object in a game. Corresponding dialogue content is transmitted to a dialogue generation service through a game client to generate a responding dialogue. Through the dialogue, a speech is generated through a speech synthesis module, and then transmitted to a video generation module (implemented through the video generation model in this disclosure) in a speech-driven facial service. Further, a video synchronous with the speech is obtained through the video generation module. Finally, the video is rendered through an engine to display the video. The virtual object in the video makes a facial expression matching the speech content, and the virtual object has a dialogue with the game object. For example, FIG. 9 is a schematic diagram of a game interface according to an aspect of this disclosure. A virtual object is displayed on the game interface, the virtual object has a dialogue with the game object, and dialogue content is displayed on the game interface. A facial expression of the virtual object matches speech content of the virtual object.

In one or more aspects of this disclosure, parallel data of a sample speech segment and a sample video segment including an object is expanded through the sample video processing model. In an example, a sample pair configured for training a video generation model is expanded, thereby reducing data costs required for training. In addition, in combination with a speech adjustment technology, generality of a model when an amount of training data is insufficient is increased.

According to one or more aspects of this disclosure, the sample speech segment and the sample video segment in the sample video segment including the object are processed through the sample video processing model, to obtain the processed sample video segment. Because the sample speech segment is synchronous with the sample video segment including the object, the sample video segment synchronous with the sample speech segment and including the virtual object is obtained, and then parallel data of the sample speech segment and the sample video segment including the virtual object are obtained. The sample video processing model obtains parallel data of the sample speech segment and the sample video segment including the virtual object, so that it does not need to construct a facial expression of the virtual object in the sample video frame by frame by an animator, thereby improving efficiency of obtaining the sample video segment including the facial expression of the virtual object. These pieces of data are configured for training the video generation model configured to generate a video segment based on a speech segment, thereby improving efficiency of obtaining training data for a video generation model and improving training efficiency for a video generation model. In addition, because costs of obtaining training data for the video generation model are reduced, costs of training the video generation model are reduced.

FIG. 4 is a flowchart of a method for training a sample video processing model according to an aspect of this disclosure. The method is performed by a computer device, and the method includes the following operations.

401: The computer device obtains at least two third sample pairs, each of the third sample pairs including a second sample video frame and a third sample video frame, an object in the second sample video frame corresponding to a virtual object in the third sample video frame, and a facial expression of the object in the second sample video frame being the same as that of the virtual object in the third sample video frame.

In one or more aspects of this disclosure, the third sample pair includes two sample video frames. A sample video frame including an object in the third sample pair is referred to as the second sample video frame, and a sample video frame including the virtual object in the third sample pair is referred to as the third sample video frame. The second sample video frame in the third sample pair may be the first sample video frame in the second sample video segment. In an example, the at least two third sample pairs may be derived from the foregoing at least two second sample pairs.

In some aspects, the second sample video frame in the third sample pair may be an adjusted sample video frame, or may be an original sample video frame. Schematically, the computer device obtains at least two third sample videos. The third sample videos are, for example, the sample videos in the foregoing at least two second sample videos. Correspondingly, a process in which the computer device obtains at least two third sample pairs includes the following operations:

The computer device adjusts at least two fourth sample video frames included in each of at least two third sample videos, to obtain at least two adjusted fourth sample video frames, an object in each of the adjusted fourth sample video frames and an object in the fourth sample video frame before adjustment having the same facial expression; and determines the at least two third sample pairs based on the at least two fourth sample video frames included in each of the at least two third sample videos, a sample video frame including the virtual object corresponding to each of the at least two fourth sample video frames, the at least two adjusted fourth sample video frames, and a sample video frame including the virtual object corresponding to each of the at least two adjusted fourth sample video frames. The second sample video frame included in each third sample pair is the fourth sample video frame before adjustment or the adjusted fourth sample video frame, and each adjusted fourth sample video frame has the same data as that of a sample video frame corresponding to the fourth sample video frame before adjustment.

In other words, after obtaining the at least two third sample videos, the computer device may adjust sample video frames in the third sample videos, and use the adjusted sample video frames as the second sample video frames in the third sample pair to participate in a process of training the sample video processing model, or may use a sample video frame before adjustment (i.e., an original sample video frame) as the second sample video frame in the third sample pair to participate in the process of training the sample video processing model.

In one or more aspects of this disclosure, the sample video frame included in each of the at least two third sample videos is adjusted, thereby increasing diversity of a sample. In addition, the sample video processing model is trained based on these multiple types of samples, which can improve generality of the sample video processing model.

In some aspects, the process in which the computer device adjusts at least two fourth sample video frames included in each of at least two third sample videos to obtain at least two adjusted fourth sample video frames includes at least one of the following: rotating, by the computer, the at least two fourth sample video frames included in each of the at least two third sample videos to obtain the at least two adjusted fourth sample video frames; or performing grayscale processing, by the computer device, on the at least two fourth sample video frames included in each of the at least two third sample videos to obtain the at least two adjusted fourth sample video frames.

In some aspects, rotating a sample video frame refers to transforming coordinates of at least two pixel points in the sample video frame through a transform matrix. A coordinate of a pixel point is multiplied by the transform matrix, to obtain the transformed coordinate of the pixel point. A sample video frame corresponding to transformed coordinates of the at least two pixel points is an adjusted sample video frame. Alternatively, using a point in a sample video frame as a rotation center, at least two pixel points in the sample video frame are rotated around the point by a preset angle. The rotation center and the preset angle may be set and modified as required, which is not specifically limited herein. The computer device may rotate the sample video frame based on at least two rotation centers and at least two preset angles, to obtain at least two adjusted sample video frames, thereby further increasing diversity of a sample.

The foregoing modes of adjusting a sample video frame may be freely combined. For example, grayscale processing is performed on a rotated sample video frame to obtain an adjusted sample video frame. The foregoing several modes are merely implementations of adjusting the sample video frame, and the computer device may further adjust the sample video frame through another implementation. Details are not described herein again.

In one or more aspects of this disclosure, the sample video frame is rotated or subjected to grayscale processing, so that a sample is expanded without changing a facial expression of an object in the sample video frame. In addition, the foregoing several adjustment modes are highly convenient, thereby improving efficiency of adjusting the sample video frame.

For example, FIG. 10 is a schematic diagram of adjustment of a sample video frame according to an aspect of this disclosure. An original sample video frame is rotated and subjected to grayscale processing, to obtain an adjusted sample video frame. The original sample video frame is a sample video frame on which grayscale processing is not performed.

402: The computer device determines, based on the second sample video frame of each of the at least two third sample pairs through the sample video processing model, a processed second sample video frame corresponding to each of the at least two third sample pairs.

In some aspects, the process in which the computer device processes, for each third sample pair, the second sample video frame in the third sample pair through the sample video processing model, to obtain a processed second sample video frame includes the following operations: The computer device processes, for each third sample pair, the second sample video frame in the third sample pair through a feature extraction module in the sample video processing model, to obtain a video frame feature of the second sample video frame, the feature extraction module being configured to extract a feature of a video frame. The video frame feature is processed through a regression module in the sample video processing model, to obtain the processed second sample video frame. The regression module is configured to generate a processed video frame based on a video frame feature.

The following illustrates an implementation of operation 402 by using an example in which the second sample video frame in the third sample pair is the adjusted fourth sample video frame with reference to Equation (6) to Equation (8).

Schematically, the third sample video is represented as X={x¹, . . . , x^{M}}, and M represents a quantity of the fourth sample video frames included in the third sample video. x^{M} represents an M^{th} frame of the fourth sample video frame.

The computer device adjusts the fourth sample video frame in the third sample video, to obtain the adjusted fourth sample video frame, namely, the second sample video frame in the third sample pair. The process may be represented through the following Equation (6).

$${x}^{′} = {aug}_{img} ( x ) . \qquad ( 6 )$$

x′ represents the adjusted fourth sample video frame, namely, the second sample video frame in the third sample pair. x represents the fourth sample video frame before adjustment, and aug_{img}(x) represents adjusting the fourth sample video frame x.

In some aspects, the feature extraction module is an ResNet network. The second sample video frame is inputted to the feature extraction module, to obtain a video frame feature. The process may be represented through the following Equation (7).

$${h}_{img} = ResNet ( {x}^{′} ) . \qquad ( 7 )$$

h_{img} represents the video frame feature, and ResNet(x′) represents extracting the second sample video frame x′ through the ResNet network.

In some aspects, an input video frame for the ResNet network has a preset resolution, for example, 256×256. Therefore, before the second sample video frame is inputted to the ResNet network, the second sample video frame is cut into a sample video frame having the resolution 256×256.

In some aspects, the regression module is a fully connected layer, and is configured to perform nonlinear transformation on the video frame feature, to obtain the processed sample video frame. The process may be implemented by using the following Equation (8).

$${y}^{′} = Linear ( {h}_{img} ) . \qquad ( 8 )$$

y′ represents the processed sample video frame, and Linear(h_{img}) represents performing nonlinear transformation on the video frame feature h_{img}.

403: The computer device trains the sample video processing model based on the processed second sample video frame corresponding to each of the at least two third sample pairs and the third sample video frame of each of the at least two third sample pairs.

In some aspects, the computer device determines, for each third sample pair, a loss value between the processed second sample video frame for the third sample pair and the third sample video frame and adjusts a model parameter of the sample video processing model based on the loss value.

The computer device performs iterative training on the sample video processing model based on the loss value between the third sample video frame of each of the at least two third sample pairs and the processed second sample video frame.

In an implementation, in each iteration process, the computer device adjusts the model parameter of the sample video processing model based on the loss value between a third sample video frame of one third sample pair and a processed second sample video frame.

For example, the loss value is the L2 loss value, and the process may be expressed through the following Equation (9).

$$L = ‖ y - {y}^{′} ‖ . \qquad ( 9 )$$

In Equation (9), L represents the loss value, y represents the third sample video frame, and y′ represents the processed second sample video frame. The third sample video frame and the processed second sample video frame are two vectors, which have the same dimension. ∥y−y′∥ represents performing calculation of a least square error on y and y′. The computer device determines a difference between each element in the processed second sample video frame and a corresponding element in the third sample video frame and determines an average value of squares of at least two differences, to obtain the loss value.

In another implementation, in each iterative training process, the computer device adjusts the model parameter of the sample video processing model based on the loss values of a part of the at least two third sample pairs. For example, the model parameter of the sample video processing model is adjusted based on loss values of at least two third sample pairs corresponding to the same sample video. The computer device adjusts the model parameter of the sample video processing model based on an average loss value of the loss values of the at least two third sample pairs. Alternatively, the computer device determines a difference between predicted sample video frame data and sample video frame data of each of the at least two third sample pairs, determines an average value of squares of at least two differences to obtain the loss value, namely, the obtained loss value being an L2 loss value, and the model parameter of the sample video processing model is adjusted based on the loss value.

In a next iteration process, the processed second sample video frame for the third sample pair used in the iteration process is predicted based on the adjusted sample video processing model and the model parameter of the sample video processing model is adjusted based on a loss value between the processed second sample video frame and the third sample video frame.

For example, FIG. 11 is a flowchart of training of a sample video processing model according to an aspect of this disclosure. An original sample video frame including an object is first adjusted, to obtain an adjusted sample video frame. The adjusted sample video frame is processed through an ResNet network in a sample video processing model, to obtain a video frame feature. The video frame feature is processed through a regression module in the sample video processing model, to obtain a sample video frame including a virtual object.

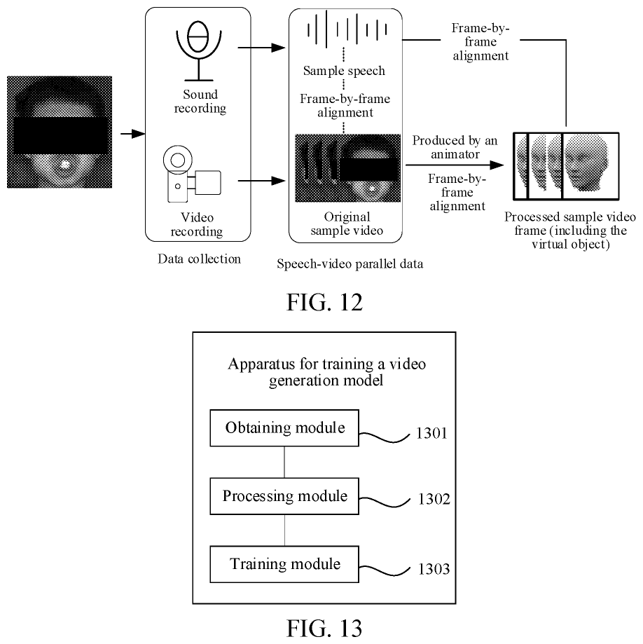

For example, FIG. 12 is a flowchart of obtaining of training data according to an aspect of this disclosure. An object performs, and the object makes a facial expression while uttering a speech. Then, a sample speech segment is obtained through recording, and an original sample video segment is obtained through video recording. Then, the sample speech segment is aligned with the original sample video segment frame by frame, to obtain at least two original sample video frames in the original sample video segment. Finally, an animator produces a sample video frame including a virtual object corresponding to each of the original sample video frames, to obtain a processed sample video segment corresponding to the original sample video segment. The processed sample video segment includes a virtual object. Because the sample speech segment is aligned with the original sample video segment frame by frame, the original sample video segment is aligned with the processed sample video segment frame by frame, and then the sample speech segment is aligned with the processed sample video segment frame by frame. In some aspects, a computer device may further use the sample speech segment and the processed sample video segment as a set of first sample pairs to improve a data utilization rate.

In some aspects, the computer device obtains at least two initial sample pairs. The at least two initial sample pairs include sample speech segments and sample video segments including an object. For example, the at least two initial sample pairs include 100 sample speech segments whose average duration is 4 s and corresponding sample video segments. Then, sample video segments in a part of initial sample pairs may be selected in various manners to produce a small quantity of sample video frames including the virtual object, to obtain at least two third sample pairs. For example, 10 sample video segments are selected to produce the sample video frames including the virtual object. Because each sample video segment including an object includes at least two sample video frames, a large quantity of third sample pairs may be obtained. Then, after training is performed based on at least two third sample pairs to obtain a sample video processing model, the remaining initial sample pairs are processed based on the sample video processing model to obtain a part of first sample pairs. The previously produced sample video frame including the virtual object is aligned with the sample speech segment frame by frame to also obtain a part of first sample pairs, and these two parts of the first sample pairs are both used as training data for the video generation model, thereby implementing data reuse.

An execution body for training a video generation model may be the same as or different from an execution body for training a sample video processing model, which is not limited herein.

In one or more aspects of this disclosure, a process of training the sample video processing model is implemented through the foregoing operations 401 to 403. In one or more aspects, the sample video processing model is trained based on the sample video frame including the object and the sample video frame including the virtual object, so that the sample video processing model can automatically generate a facial expression of a virtual object in a processed sample video frame based on a facial expression of a real object in the sample video frame. Therefore, when a training sample pair of a sample speech segment and a virtual sample video segment (i.e., the sample video segment including the virtual object) is obtained, the sample video processing model processes, based on a real video segment synchronized with speech content, the real video segment to obtain a virtual sample video segment corresponding to the real video segment. Because the speech segment is synchronized with the real video segment, the obtained virtual sample video segment is synchronized with the speech segment. Accordingly, efficiency of obtaining a training sample pair of a speech segment and a virtual sample video segment is improved through the sample video processing model.

FIG. 13 is a block diagram of an apparatus for training a video generation model according to an aspect of this disclosure. Referring to FIG. 13, the apparatus includes:
an obtaining module 1301, configured to obtain at least two first sample pairs, each of the first sample pairs including a first sample speech segment and a first sample video segment corresponding to the first sample speech segment, and a facial expression of a virtual object in the first sample video segment matching speech content of the first sample speech segment;
a processing module 1302, configured to determine, through a video generation model based on the first sample speech segment of each of the at least two first sample pairs, a predicted video segment corresponding to the first sample speech segment of each of the at least two first sample pairs, the video generation model being configured to generate a video segment based on a speech segment; and
a training module 1303, configured to train the video generation model based on the predicted video segment and the first sample video segment corresponding to the first sample speech segment of each of the at least two first sample pairs.

In some aspects, the obtaining module 1301 is configured to:
obtain at least two second sample pairs, each of the second sample pairs including a second sample speech segment and a second sample video segment corresponding to the second sample speech segment, and a facial expression of an object in the second sample video segment matching speech content of the second sample speech segment;
determine, through a sample video processing model based on a second sample video segment of each of the at least two second sample pairs, a processed second sample video segment corresponding to each of the at least two second sample pairs, a facial expression of a virtual object in the processed second sample video segment matching a facial expression of an object in the second sample video segment before processing, and the sample video processing model being configured to generate, based on a sample video segment including the object, a sample video segment including the virtual object; and
determine the at least two first sample pairs based on the second sample speech segment of each of the at least two second sample pairs and the processed second sample video segment corresponding to each of the at least two second sample pairs.

In some aspects, the obtaining module 1301 is configured to:
determine, for each second sample pair, through the sample video processing model based on at least two first sample video frames in the second sample video segment of the second sample pair, a processed first sample video frame corresponding to each of the at least two first sample video frames; and
determine the processed second sample video segment corresponding to each of the at least two second sample pairs based on the processed first sample video frame corresponding to each of the at least two second sample pairs.

In some aspects, the obtaining module 1301 is configured to:
adjust the second sample speech segment of each of the at least two second sample pairs, to obtain at least two adjusted second sample speech segments, speech content in each of the adjusted second sample speech segments being the same as that in the second sample speech segment before adjustment; and
determine the at least two first sample pairs based on the second sample speech segment of each of the at least two second sample pairs, the at least two adjusted second sample speech segments, and the processed second sample video segment corresponding to each of the at least two second sample pairs.

The first sample speech segment in each first sample pair is the second sample speech segment before the adjustment or the adjusted second sample speech segment, and each adjusted second sample speech segment and the second sample speech segment before the adjustment corresponding to the same second sample video segment.

In some aspects, the obtaining module 1301 is configured to perform at least one of the following:
adjusting a pitch of the second sample speech segment of each of the at least two second sample pairs, to obtain the at least two adjusted second sample speech segments;
adding reverberation to the second sample speech segment of each of the at least two second sample pairs, to obtain the at least two adjusted second sample speech segments; and
adding noise to the second sample speech segment of each of the at least two second sample pairs, to obtain the at least two adjusted second sample speech segments.

In some aspects, the training module 1303 is further configured to:
obtain at least two third sample pairs, each of the third sample pairs including a second sample video frame and a third sample video frame, an object in the second sample video frame corresponding to a virtual object in the third sample video frame, and a facial expression of the object in the second sample video frame being the same as that of the virtual object in the third sample video frame;
determine, by the sample video processing model based on the second sample video frame of each of the at least two third sample pairs, a processed second sample video frame corresponding to each of the at least two third sample pairs; and
train the sample video processing model based on the processed second sample video frame corresponding to each of the at least two third sample pairs and the third sample video frame of each of the at least two third sample pairs.

In some aspects, the obtaining module 1301 is further configured to:
adjust at least two fourth sample video frames included in each of the at least two third sample videos, to obtain at least two adjusted fourth sample video frames, objects in each of the adjusted fourth sample video frames and the fourth sample video frame before adjustment having the same facial expression; and
determine the at least two third sample pairs based on the at least two fourth sample video frames included in each of the at least two third sample videos and the at least two adjusted fourth sample video frames.

The second sample video frame in each third sample pair is the fourth sample video frame before adjustment or the adjusted fourth sample video frame, and each adjusted fourth sample video frame and the fourth sample video frame before adjustment correspond to the same sample video frame data.

In some aspects, the obtaining module 1301 is configured to perform at least one of the following:
rotating at least two fourth sample video frames included in each of the at least two third sample videos, to obtain the at least two adjusted fourth sample video frames; and
performing grayscale processing on at least two fourth sample video frames included in each of the at least two third sample videos, to obtain the at least two adjusted fourth sample video frames.

In some aspects, the predicted video segment includes at least two predicted video frames. The first sample video segment includes at least two sample video frames. The at least two predicted video frames are in one-to-one correspondence with the at least two sample video frames. The training module 1303 is configured to:
determine, for each first sample pair, a loss value based on a difference between each of the at least two predicted video frames and each of the at least two sample video frames; and
adjust a model parameter of the video generation model based on the loss value corresponding to each of the at least two first sample pairs.

One or more aspects of this disclosure provide an apparatus for training a video generation model. The apparatus trains the video generation model based on a sample speech segment and a sample video segment corresponding to the sample speech segment. A facial expression of a virtual object in the sample video segment matches speech content of the sample speech segment, and then, the video generation model is continuously trained through the sample video segment as a target, so that the video generation model can gradually learn how to more accurately generate, based on a speech segment, a facial expression matching the speech content. The video generation model obtained through training as described herein may generate a video segment synchronous with a speech segment, and in the video segment, a facial expression of a virtual object matches the speech content. In an example, by using the video generation model obtained through training, the facial expression matching the speech content can be generated for the virtual object based on the speech segment. For example, when the video generation model obtained through training is applied to a live streaming scenario through a virtual person, a more natural and accurate facial expression can be generated for the virtual person, thereby improving user experience. In addition, the facial expression is generated based on the video generation model, so that convenience and efficiency of generating the facial expression can be improved.

In one or more aspects of this disclosure, the computer device may be a terminal or a server. When the computer device is the terminal, the technical solutions provided in one or more aspects of this disclosure are implemented by the terminal as an execution body. When the computer device is the server, the technical solutions provided in one or more aspects of this disclosure are implemented by the server as the execution body. Alternatively, the technical solutions provided in this disclosure are implemented by interaction between the terminal and the server. This is not limited in one or more aspects of this disclosure.

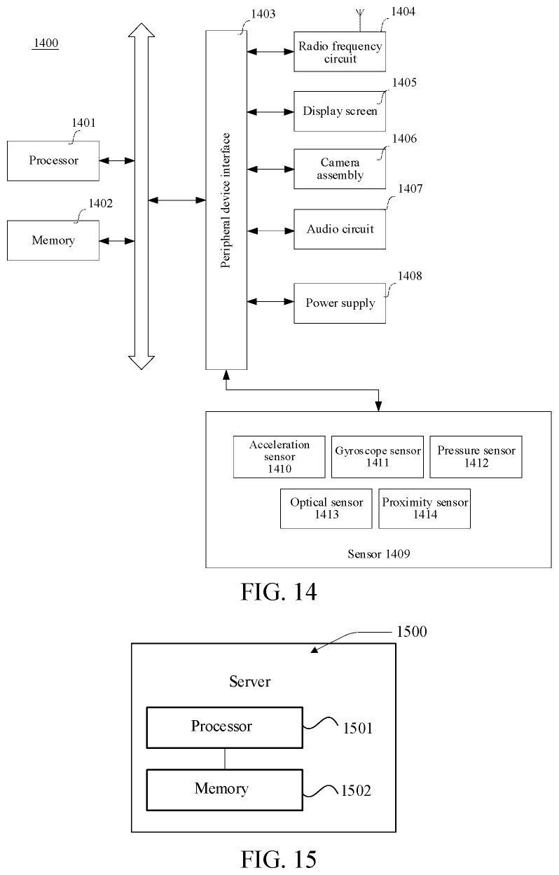

FIG. 14 is a structural block diagram of a terminal 1400 according to an aspect of this disclosure.

The terminal 1400 includes processing circuitry (e.g., a processor 1401) and a memory 1402 (e.g., including a non-transitory computer-readable storage medium).

The processor 1401 may include one or at least two processing cores, for example, a 4-core processor or an 8-core processor. The processor 1401 may be implemented by using at least one of the following hardware forms: a digital signal processor (DSP), a field-programmable gate array (FPGA), or a programmable logic array (PLA). The processor 1401 may alternatively include a main processor and a coprocessor. The main processor is a processor configured to process data in an awake state, and is also referred to as a central processing unit (CPU). The coprocessor is a low power processor configured to process data in a standby state. In some aspects, the processor 1401 may be integrated with a graphics processing unit (GPU). The GPU is configured to render and draw content that needs to be displayed on a display screen. In some aspects, the processor 1401 may further include an AI processor. The AI processor is configured to process computing operations related to machine learning.

The memory 1402 may include one or at least two computer-readable storage media. The computer-readable storage medium may be non-transitory. The memory 1402 may further include a high-speed random access memory (RAM) and a nonvolatile memory, for example, one or at least two disk storage devices or flash storage devices. In some aspects, the non-transitory computer-readable storage medium in the memory 1402 is configured to store at least one program (e.g., instructions). The at least one program is configured to be executed by the processor 1401 to implement a method for training a video generation model provided according to one or more examples in this disclosure.

In some aspects, the terminal 1400 may further include a peripheral device interface 1403 and at least one peripheral device. The processor 1401, the memory 1402, and the peripheral interface 1403 may be connected through a bus or a signal line. Each peripheral may be connected to the peripheral device interface 1403 through a bus, a signal line, or a circuit board. In an example, the peripheral device includes at least one of a radio frequency (RF) circuit 1404, a display screen 1405, a camera assembly 1406, an audio circuit 1407, or a power supply 1408.

The peripheral device interface 1403 may be configured to connect the at least one peripheral device related to input/output (I/O) to the processor 1401 and the memory 1402. In some aspects, the processor 1401, the memory 1402, and the peripheral device interface 1403 are integrated on the same chip or the same circuit board. In some other aspects, any one or two of the processor 1401, the memory 1402, and the peripheral device interface 1403 may be implemented on a separate chip or a separate circuit board, which is not limited in this disclosure.

The RF circuit 1404 is configured to receive and transmit an RF signal, which is also referred to as an electromagnetic signal. The RF circuit 1404 communicates with a communication network and another communication device through the electromagnetic signal. The RF circuit 1404 converts an electrical signal into an electromagnetic signal for transmission, or converts a received electromagnetic signal into an electrical signal. In some aspects, the RF circuit 1404 includes an antenna system, an RF transceiver, one or at least two amplifiers, a tuner, an oscillator, a DSP, a codec chipset, a subscriber identity module card, and the like. The RF circuit 1404 may communicate with another terminal through at least one wireless communication protocol. The wireless communication protocol includes, but is not limited to, a World Wide Web, a metropolitan area network, an intranet, generations of mobile communication networks (2G, 3G, 4G, and 5G), a wireless local area network, and/or a Wi-Fi network. In some aspects, the RF circuit 1404 may further include a circuit related to near field communication (NFC), which is not limited in this disclosure.

The display screen 1405 is configured to display a user interface (UI). The UI may include a graph, texts, an icon, a video, and any combination thereof. When the display screen 1405 is a touch display screen, the display screen 1405 further has a capability of collecting a touch signal on or above a surface of the display screen 1405. The touch signal may be inputted to the processor 1401 as a control signal for processing. In this case, the display screen 1405 may be further configured to provide a virtual button and/or a virtual keyboard, which are/is also referred to as a soft button and/or a soft keyboard. In some aspects, one display screen 1405 may be provided, which is arranged on a front panel of the terminal 1400. In some other aspects, at least two display screen 1405 may be provided, which are respectively arranged on different surfaces of the terminal 1400 or in a folded design. In some still other aspects, the display screen 1405 may be a flexible display screen, which is arranged on a curved surface or a folded surface of the terminal 1400. The display screen 1405 may be even arranged as a non-rectangular irregular figure, namely, a special-shaped screen. The display screen 1405 may be manufactured through a material such as a liquid crystal display (LCD) or an organic light-emitting diode (OLED).

The camera assembly 1406 is configured to capture an image or a video. In some aspects, the camera assembly 1406 includes a front camera and a rear camera. In one or more examples, the front camera is arranged on the front panel of the terminal, and the rear camera is arranged on the back of the terminal. In some aspects, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and VR photographing through fusion of the main camera and the wide-angle camera, or another fusion photographing function. In some aspects, the camera assembly 1406 may further include a flash. The flash may be a single-color-temperature flash, or may be a dual-color-temperature flash. The dual-color-temperature flash is a combination of a warm flash and a cold flash, which may be configured for light compensation at different color temperatures.

The audio circuit 1407 may include a microphone and a speaker. The microphone is configured to acquire sound waves of a user and an environment, and convert the sound wave into an electrical signal to be inputted to the processor 1401 for processing, or inputted to the RF circuit 1404 for implementing voice communication. For the purpose of stereo acquisition or noise reduction, at least two microphones may be arranged at different parts of the terminal 1400. The microphone may be further an array microphone or an omni-directional acquisition microphone. The speaker is configured to convert the electrical signals from the processor 1401 or the RF circuit 1404 into sound waves. The speaker may be a film speaker, or may be a piezoelectric ceramic speaker. When the speaker is the piezoelectric ceramic speaker, the speaker not only may convert an electric signal into the sound wave audible to human, but also may convert the electric signal into the sound wave inaudible to the human for purposes such as ranging. In some aspects, the audio circuit 1407 may further include an earphone jack.

The power supply 1408 is configured to supply power to components in the terminal 1400. The power supply 1408 may be an alternating current, a direct current, a disposable battery, or a rechargeable battery. When the power supply 1408 includes the rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery is further configured to support a fast charging technology.

In some aspects, the terminal 1400 further includes one or at least two sensors 1409. The one or at least two sensors 1409 include, but are not limited to, an acceleration sensor 1410, a gyroscope sensor 1411, a pressure sensor 1412, an optical sensor 1413, and a proximity sensor 1414.

The acceleration sensor 1410 may detect a magnitude of acceleration on three coordinate axes of a coordinate system established with the terminal 1400. For example, the acceleration sensor 1410 may be configured to detect components of acceleration of gravity on the three coordinate axes. The processor 1401 may control, based on a gravity acceleration signal collected by the acceleration sensor 1410, the display screen 1405 to display the UI in a landscape view or a portrait view. The acceleration sensor 1410 may be further configured to collect motion data of a game or a user.

The gyroscope sensor 1411 may detect a body direction and a rotation angle of the terminal 1400. The gyroscope sensor 1411 may cooperate with the acceleration sensor 1410 to acquire a 3D action by the user on the terminal 1400. The processor 1401 may implement the following functions based on the data collected by the gyroscope sensor 1411: motion sensing (for example, change of the UI based on a tilt operation of the user), image stabilization during photographing, game control, and inertial navigation.

The pressure sensor 1412 may be arranged at a side frame of the terminal 1400 and/or a lower layer of the display screen 1405. When the pressure sensor 1412 is arranged at the side frame of the terminal 1400, a holding signal of the user on the terminal 1400 may be detected. The processor 1401 performs left/right hand recognition or a quick operation based on the holding signal acquired by the pressure sensor 1412. When the pressure sensor 1412 is arranged on the lower layer of the display screen 1405, the processor 1401 controls, based on a pressure operation of the user on the display screen 1405, an operable control on the UI. The operable control includes at least one of a button control, a scroll-bar control, an icon control, or a menu control.

The optical sensor 1413 is configured to collect ambient light intensity. In an aspect, the processor 1401 may control display brightness of the display screen 1405 based on the ambient light intensity collected by the optical sensor 1413. In an example, when the ambient light intensity is relatively high, the display brightness of the display screen 1405 is increased. When the ambient light intensity is relatively low, the display brightness of the display screen 1405 is decreased. In another aspect, the processor 1401 further dynamically adjusts a shooting parameter of the camera assembly 1406 based on the ambient light intensity collected by the optical sensor 1413.

The proximity sensor 1414, also referred to as a distance sensor, is usually arranged on the front panel of the terminal 1400. The proximity sensor 1414 is configured to collect a distance between a user and a front surface of the terminal 1400. In one or more aspects, when the proximity sensor 1414 detects that the distance between the user and the front surface of the terminal 1400 gradually decreases, the processor 1401 controls the display screen 1405 to be switched from a screen-on state to a screen-off state. When the proximity sensor 1414 detects that the distance between the user and the front surface of the terminal 1400 gradually increases, the processor 1401 controls the display screen 1405 to be switched from the screen-off state to the screen-on state.

A person skilled in the art may understand that the structure shown in FIG. 14 does not constitute a limitation on the terminal 1400. The terminal may include more or fewer components than those shown in the figure, or some merged components, or different component arrangements.

FIG. 15 is a schematic structural diagram of a server according to an aspect of this disclosure. The server 1500 may vary considerably in configuration or performance, and may include one or more processors (Central Processing Units, CPU) 1501 and one or more memories 1502. The memory 1502 is configured to store at least one program, and the processor 1501 is configured to execute the foregoing at least one program to implement the method for training a video generation model provided in the foregoing examples. In an example, the server may further have components such as a wired or wireless network interface, a keyboard, and an I/O interface, to perform input and output. The server may further include another component configured to implement a device function. Further details are not described herein.

One or more aspects of this disclosure further provides a computer-readable storage medium. The computer-readable storage medium stores at least one program. The at least one program is loaded and executed by a processor to implement the method for training a video generation model according to any one of the foregoing implementations.

One or more aspects of this disclosure further provides a computer program product. The computer program product includes at least one program. The at least one program is stored in a non-transitory computer-readable storage medium. A processor of a computer device reads the at least one program from the non-transitory computer-readable storage medium. The processor executes the at least one program to cause the computer device to perform the method for training a video generation model according to any one of the foregoing implementations.

In some aspects, the computer program product involved in this disclosure may be deployed on a computer device for execution, or executed on at least two computer devices located at a position, or executed on at least two computer devices distributed at at least two positions and connected through a communication network. The at least two computer devices distributed at the at least two positions and connected by the communication network may form a blockchain system.

As used in this disclosure, “at least one of A, B, or C” is intended to include any one of A alone, B alone, C alone, or any combination of A, B, and C. As used in this disclosure, “one of A or B” includes A, B, or both A and B.

Modules, submodules, and units described in this disclosure may be implemented by processing circuitry (e.g., a processor executing software stored in memory), hardware, firmware, or a combination thereof. Software modules, when executed by processing circuitry, cause the processing circuitry to perform the described functions. Hardware modules may be implemented as dedicated circuits, field-programmable gate arrays (FPGAs), application-specific integrated circuits (ASICs), or other hardware components. References to a processor and memory in this disclosure encompass processing circuitry and non-transitory computer-readable storage media, respectively.

The foregoing technical solutions may be combined in different ways to form an implementation consistent with the disclosure. Details are not described herein again. The foregoing descriptions are merely examples of this disclosure, but are not intended to limit this disclosure. Any modification, equivalent replacement, or improvement made within the spirit and principle of this disclosure shall fall within the scope of this disclosure.

What is claimed is:

1. A method for video generation model training, the method comprising:
obtaining at least two first sample pairs, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs;
generating, by processing circuitry through a video generation model based on the first sample speech segment of each of the first sample pairs, a respective predicted video segment corresponding to the first sample speech segment of each of the first sample pairs; and
training, by the processing circuitry, the video generation model based on the predicted video segment and the first sample video segment corresponding to the first sample speech segment of each of the first sample pairs.

2. The method according to claim 1, wherein the obtaining the at least two first sample pairs comprises:
obtaining at least two second sample pairs, each of the second sample pairs including a second sample speech segment and a second sample video segment corresponding to the second sample speech segment, the second sample video segment of each of the second sample pairs including images of a respective object, and a facial expression of the object in the second sample video segment of each of the second sample pairs matching speech content of the second sample speech segment of the corresponding one of the second sample pairs;
generating, through a sample video processing model based on the second sample video segment of each of the second sample pairs, a respective processed second sample video segment corresponding to each of the second sample pairs, the processed second sample video segment corresponding to each of the second sample pairs including images of a virtual object corresponding to the respective object, a facial expression of the virtual object in the processed second sample video segment matching a facial expression of the respective object in the second sample video segment of the corresponding one of the second sample pairs; and
determining the first sample pairs based on the second sample speech segment of each of the second sample pairs and the processed second sample video segment corresponding to each of the second sample pairs.

3. The method according to claim 2, wherein the generating the respective processed second sample video segment comprises:
determining, for each one of the second sample pairs, through the sample video processing model based on at least two first sample video frames in the second sample video segment of the corresponding one of the second sample pairs, a processed first sample video frame corresponding to each of the first sample video frames; and
determining the processed second sample video segment corresponding to each of the second sample pairs based on the processed first sample video frames corresponding to each of the second sample pairs.

4. The method according to claim 2, wherein the determining the first sample pairs comprises:
adjusting the second sample speech segment of each of the second sample pairs, to obtain at least two adjusted second sample speech segments, speech content in each of the adjusted second sample speech segments being same as that in the corresponding second sample speech segment; and
determining the first sample pairs based on the second sample speech segment of each of the second sample pairs, the adjusted second sample speech segments, and the processed second sample video segment corresponding to each of the second sample pairs,
each of the first sample pairs being the second sample video segment of the corresponding one of the second sample pairs paired with the corresponding second sample speech segment or the corresponding adjusted second sample speech segment.

5. The method according to claim 4, wherein the adjusting the second sample speech segment of each of the second sample pairs comprises:
adjusting a pitch of the second sample speech segment of each of the second sample pairs, to obtain the adjusted second sample speech segments;
adding reverberation to the second sample speech segment of each of the second sample pairs, to obtain the adjusted second sample speech segment; or
adding noise to the second sample speech segment of each of the second sample pairs, to obtain the adjusted second sample speech segment.

6. The method according to claim 2, further comprising:
obtaining at least two third sample pairs, each of the third sample pairs including a second sample video frame and a third sample video frame, a virtual object in the third sample video frame corresponding to an object in the second sample video frame, and a facial expression of the object in the second sample video frame being same as that of the virtual object in the third sample video frame;
generating, through the sample video processing model based on the second sample video frame of each of the third sample pairs, a processed second sample video frame corresponding to each of the third sample pairs; and
training the sample video processing model based on the processed second sample video frame corresponding to each of the third sample pairs and the corresponding third sample video frame of each of the third sample pairs.

7. The method according to claim 6, wherein the obtaining the at least two third sample pairs comprises:
obtaining at least two third sample video segments;
adjusting at least two fourth sample video frames in each of the third sample video segments, to obtain at least two adjusted fourth sample video frames, objects in each of the adjusted fourth sample video frames and the fourth sample video frame corresponding thereto having a same facial expression; and
determining the third sample pairs based on the fourth sample video frames in each of the third sample video segments and the corresponding adjusted fourth sample video frames,
the second sample video frame in each of the third sample pairs being one of the fourth sample video frames or the corresponding one of the adjusted fourth sample video frame.

8. The method according to claim 7, wherein the adjusting the at least two fourth sample video frames comprises:
rotating the fourth sample video frames in each of the third sample video segments, to obtain the corresponding adjusted fourth sample video frames; or
performing grayscale processing on the fourth sample video frames in each of the third sample videos, to obtain the corresponding adjusted fourth sample video frames.

9. The method according to claim 1, wherein
the predicted video segment corresponding to one of the first sample pairs includes at least two predicted video frames, the corresponding first sample video segment includes at least two sample video frames, and the predicted video frames are in one-to-one correspondence with the sample video frames; and
the training the video generation model includes:
determining, for each of the first sample pairs, a loss value based on a difference between each of the predicted video frames and each of the sample video frames; and
adjusting a model parameter of the video generation model based on the loss value corresponding to each of the first sample pairs.

10. An apparatus for video generation model training, comprising:
processing circuitry configured to:
obtain at least two first sample pairs, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs;
generate, through a video generation model based on the first sample speech segment of each of the first sample pairs, a respective predicted video segment corresponding to the first sample speech segment of each of the first sample pairs; and
train the video generation model based on the predicted video segment and the first sample video segment corresponding to the first sample speech segment of each of the first sample pairs.

11. The apparatus according to claim 10, wherein the processing circuitry is configured to:
obtain at least two second sample pairs, each of the second sample pairs including a second sample speech segment and a second sample video segment corresponding to the second sample speech segment, the second sample video segment of each of the second sample pairs including images of a respective object, and a facial expression of the object in the second sample video segment of each of the second sample pairs matching speech content of the second sample speech segment of the corresponding one of the second sample pairs;
generate, through a sample video processing model based on the second sample video segment of each of the second sample pairs, a respective processed second sample video segment corresponding to each of the second sample pairs, the processed second sample video segment corresponding to each of the second sample pairs including images of a virtual object corresponding to the respective object, a facial expression of the virtual object in the processed second sample video segment matching a facial expression of the respective object in the second sample video segment of the corresponding one of the second sample pairs; and
determine the first sample pairs based on the second sample speech segment of each of the second sample pairs and the processed second sample video segment corresponding to each of the second sample pairs.

12. The apparatus according to claim 11, wherein the processing circuitry is configured to:
determine, for each one of the second sample pairs, through the sample video processing model based on at least two first sample video frames in the second sample video segment of the corresponding one of the second sample pairs, a processed first sample video frame corresponding to each of the first sample video frames; and
determine the processed second sample video corresponding to each of the second sample pairs based on the processed first sample video frames corresponding to each of the second sample pairs.

13. The apparatus according to claim 11, wherein the processing circuitry is configured to:
adjust the second sample speech segment of each of the second sample pairs, to obtain at least two adjusted second sample speech segments, speech content in each of the adjusted second sample speech segments being same as that in the corresponding second sample speech segment; and
determine the first sample pairs based on the second sample speech segment of each of the second sample pairs, the adjusted second sample speech segments, and the processed second sample video segment corresponding to each of the second sample pairs,
each of the first sample pairs being the second sample video segment of the corresponding one of the second sample pairs paired with the corresponding second sample speech segment or the corresponding adjusted second sample speech segment.

14. The apparatus according to claim 13, wherein the processing circuitry is configured to:
adjust a pitch of the second sample speech segment of each of the second sample pairs, to obtain the adjusted second sample speech segments;
add reverberation to the second sample speech segment of each of the second sample pairs, to obtain the adjusted second sample speech segment; or
add noise to the second sample speech segment of each of the second sample pairs, to obtain the adjusted second sample speech segment.

15. The apparatus according to claim 11, wherein the processing circuitry is configured to:
obtain at least two third sample pairs, each of the third sample pairs including a second sample video frame and a third sample video frame, a virtual object in the third sample video frame corresponding to an object in the second sample video frame, and a facial expression of the object in the second sample video frame being same as that of the virtual object in the third sample video frame;
generate, through the sample video processing model based on the second sample video frame of each of the third sample pairs, a processed second sample video frame corresponding to each of the third sample pairs; and
train the sample video processing model based on the processed second sample video frame corresponding to each of the third sample pairs and the corresponding third sample video frame of each of the third sample pairs.

16. The apparatus according to claim 15, wherein the processing circuitry is configured to:
obtain at least two third sample video segments;
adjust at least two fourth sample video frames in each of the third sample video segments, to obtain at least two adjusted fourth sample video frames, objects in each of the adjusted fourth sample video frames and the fourth sample video frame corresponding thereto having a same facial expression; and
determine the third sample pairs based on the fourth sample video frames in each of the third sample video segments and the corresponding adjusted fourth sample video frames,
the second sample video frame in each of the third sample pairs being one of the fourth sample video frames or the corresponding one of the adjusted fourth sample video frame.

17. The apparatus according to claim 16, wherein the processing circuitry is configured to:
rotate the fourth sample video frames in each of the third sample video segments, to obtain the corresponding adjusted fourth sample video frames; or
perform grayscale processing on the fourth sample video frames in each of the third sample videos, to obtain the corresponding adjusted fourth sample video frames.

18. The apparatus according to claim 10, wherein
the predicted video segment corresponding to one of the first sample pairs includes at least two predicted video frames, the corresponding first sample video segment includes at least two sample video frames, and the predicted video frames are in one-to-one correspondence with the sample video frames; and
the processing circuitry is configured to:
determine, for each of the first sample pairs, a loss value based on a difference between each of the predicted video frames and each of the sample video frames; and
adjust a model parameter of the video generation model based on the loss value corresponding to each of the first sample pairs.

19. A non-transitory computer-readable storage medium storing instructions, which when executed by a processor, cause the processor to perform a method for video generation model training, the method comprising:
obtaining at least two first sample pairs, each of the first sample pairs including a first sample speech segment and a first sample video segment corresponding to the first sample speech segment, the first sample video segment of each of the first sample pairs including images of a respective virtual object, and a facial expression of the virtual object in the first sample video segment of each of the first sample pairs matching speech content of the first sample speech segment of the corresponding one of the first sample pairs;
generating, through a video generation model based on the first sample speech segment of each of the first sample pairs, a respective predicted video segment corresponding to the first sample speech segment of each of the first sample pairs; and
training the video generation model based on the predicted video segment and the first sample video segment corresponding to the first sample speech segment of each of the first sample pairs.

20. The non-transitory computer-readable storage medium according to claim 19, wherein the obtaining the at least two first sample pairs comprises:
obtaining at least two second sample pairs, each of the second sample pairs including a second sample speech segment and a second sample video segment corresponding to the second sample speech segment, the second sample video segment of each of the second sample pairs including images of a respective object, and a facial expression of the object in the second sample video segment of each of the second sample pairs matching speech content of the second sample speech segment of the corresponding one of the second sample pairs;
generating, through a sample video processing model based on the second sample video segment of each of the second sample pairs, a respective processed second sample video segment corresponding to each of the second sample pairs, the processed second sample video segment corresponding to each of the second sample pairs including images of a virtual object corresponding to the respective object, a facial expression of the virtual object in the processed second sample video segment matching a facial expression of the respective object in the second sample video segment of the corresponding one of the second sample pairs; and
determining the first sample pairs based on the second sample speech segment of each of the second sample pairs and the processed second sample video segment corresponding to each of the second sample pairs.
